(19) United States
(12) Patent Application Publication
(10) Pub. No.: US 2025/0219162 A1
(43) Pub. Date: Jul. 3, 2025

(54) SEPARATOR FOR RECHARGEABLE LITHIUM BATTERY AND RECHARGEABLE LITHIUM BATTERY INCLUDING SAME

(71) Applicant: SAMSUNG SDI CO., LTD., Gyeonggi-do (KR)

(72) Inventors: Tae Jin LEE, Gyeonggi-do (KR); Myungheui WOO, Gyeonggi-do (KR); Sanghoon KIM, Gyeonggi-do (KR); Arum YU, Gyeonggi-do (KR)

(73) Assignee: SAMSUNG SDI CO., LTD., Gyeonggi-do (KR)

(21) Appl. No.: 18/852,742

(22) PCT Filed: Jun. 3, 2022
(86) PCT No.: PCT/KR2022/007909

§ 371 Date: Sep. 30, 2024

(30) Foreign Application Priority Data
Apr. 1, 2022 (KR) 10-2022-0041244

(51) Int. Cl. H01M 10/42; C08K 5/00; C09D 7/63; C09D 127/16; H01M 10/0525; H01M 50/417; H01M 50/42; H01M 50/457; H01M 50/489

(52) U.S. Cl. CPC H01M 10/4235; C09D 7/63; C09D 127/16; H01M 10/0525; H01M 50/417; H01M 50/42; H01M 50/457; H01M 50/489; C08K 5/0091

(57) ABSTRACT

Disclosed are a separator for a rechargeable lithium battery and a rechargeable lithium battery including the same. Specifically, an embodiment provides a separator for a rechargeable lithium battery including a substrate; and a coating layer located on one or both surfaces of the substrate and including a metal organic framework (MOF) of ZIF-8, Fe-BTC, or a combination thereof.

### TECHNICAL FIELD

A separator for a rechargeable lithium battery and a rechargeable lithium battery including the same are disclosed.

### BACKGROUND ART

Rechargeable lithium batteries are in the spotlight as power sources for driving medium to large devices such as hybrid vehicles and battery vehicles as well as small devices such as mobile phones, notebook computers, and smart phones.

When these rechargeable lithium batteries are exposed to misuse conditions such as overcharging and the like and extreme conditions such as heat exposure and the like, while thermal runaway occurs, since an amount of gas generated thereinside and thus sharply increases, the rechargeable lithium batteries may explode.

A method of reducing the amount of generated gas by coating the surface of an active material or by adding a film-forming additive to an electrolyte is known to some extent. However, the method is no longer effective, when the rechargeable lithium batteries enter a thermal runaway situation due to a short circuit.

### DISCLOSURE

### Technical Problem

An embodiment is to suppress a rapid increase of an amount of gas generated in a rechargeable lithium battery when it enters a thermal runaway situation.

### Technical Solution

In an embodiment, a separator for a rechargeable lithium battery includes a separator for a rechargeable lithium battery includes a substrate; and a coating layer located on one or both surfaces of the substrate and including a metal organic framework (MOF) of ZIF-8, Fe-BTC, or a combination thereof.

Another embodiment provides a rechargeable lithium battery including the separator for a rechargeable lithium battery.

### Advantageous Effects

In the separator for a rechargeable lithium battery of the embodiment, the metal organic framework structure, which is ZIF-8, Fe-BTC or a combination thereof, is a material capable of effectively capturing gas through an adsorption reaction.

Accordingly, a rechargeable lithium battery including a separator coated on one or both surfaces with a metal organic framework structure, which is ZIF-8, Fe-BTC, or a combination thereof, has a significantly reduced risk of explosion even when a thermal runaway situation occurs and the amount of gas generated therein rapidly increases, as the metal organic framework captures the rapidly increasing gas.

### DESCRIPTION OF THE DRAWINGS

FIG. 1 illustrates various examples of shapes (patterns) of a coating layer formed according to an embodiment.

FIG. 2 is a perspective view of a pouch type rechargeable battery according to an embodiment.

FIG. 3 is a vertical cross-sectional view taken along line I-I in FIG. 2 in the direction of the arrow.

FIG. 4 is a horizontal cross-sectional view taken along line II-II in FIG. 2 in the direction of the arrow.

### BEST MODE

Hereinafter, specific embodiments will be described in detail so that those of ordinary skill in the art can easily implement them. However, this disclosure may be embodied in many different forms and is not construed as limited to the example embodiments set forth herein.

The terminology used herein is used to describe embodiments only, and is not intended to limit the present disclosure. The singular expression includes the plural expression unless the context clearly dictates otherwise.

“Combination thereof” refers to a mixture, a laminate, a composite, a copolymer, an alloy, a blend, a reaction product, and the like of constituents.

It should be understood that terms such as “comprises,” “includes,” or “have” are intended to designate the presence of an embodied feature, number, step, element, or a combination thereof, but it does not preclude the possibility of the presence or addition of one or more other features, number, step, element, or a combination thereof.

In the drawings, the thickness of layers, films, panels, regions, etc., are exaggerated for clarity and like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

The “layer” includes not only a shape formed on the whole surface when viewed from a plan view, but also a shape formed on a partial surface.

The “particle diameter” or “average particle diameter” may be measured by a method well known to those skilled in the art, for example, may be measured by a particle size analyzer, or may be measured by a transmission electron micrograph or a scanning electron micrograph. Alternatively, it is possible to obtain an average particle diameter value by measuring using a dynamic light scattering method, performing data analysis, counting the number of particles for each particle size range, and calculating from this. Unless otherwise defined, the average particle diameter may mean the diameter (D50) of particles having a cumulative volume of 50 volume % in the particle size distribution.

The “thickness” may be measured through a photograph taken with a thickness meter or an optical microscope such as a scanning electron microscope. Additionally, the “area” may be measured through photographs taken with an optical microscope, such as a scanning electron microscope.

### [Separator for Rechargeable Lithium Battery]

In an embodiment, a separator for a rechargeable lithium battery includes a separator for a rechargeable lithium battery includes a substrate; and a coating layer located on one or both surfaces of the substrate and including a metal organic framework (MOF) of ZIF-8, Fe-BTC, or a combination thereof.

The metal organic framework is a material capable of effectively trapping gas through an adsorption reaction. In particular, a rechargeable lithium battery including a separator coated on one or both surfaces with a metal organic framework structure, which is ZIF-8. Fe-BTC or a combination thereof, has a significantly reduced risk of explosion even when a thermal runaway situation occurs and the amount of gas generated therein rapidly increases, as the metal organic framework captures the rapidly increasing gas.

Hereinafter, the separator for a rechargeable lithium battery of the embodiment will be described in detail.

### Structure of Metal Organic Framework

The metal organic framework is a material in which clusters including metal ions or metals are connected by organic ligands, and is a type of coordination polymer. The metal organic framework has a cage that is an empty space therein by forming a three-dimensional structure. As a result, the metal organic framework may undergo an adsorption reaction through the cage and trap gas into the cage.

On the other hand, zeolite, which is a crystalline aluminum silicate mineral, has an inferior gas trapping effect, compared with the metal organic framework. The gas adsorption reaction is a reaction in which gas molecules are adsorbed on the surface of a cage inside the material structure. In general, the larger a specific surface area, the more gas molecules may be adsorbed. According to the results of several previous studies, which compare specific surface areas of zeolite and representative materials with the metal organic framework, the metal organic framework has been reported to have a larger specific surface area than that of the zeolite. Accordingly, the metal organic framework may have a larger surface area for gas adsorption than the zeolite. Particularly, in a rechargeable lithium battery using a nickel-based positive electrode active material including 90% or more of Ni as a positive electrode active material, the metal organic framework exhibits a very excellent gas trapping effect, but the zeolite exhibits a very inferior gas trapping effect. This fact is confirmed in evaluation examples described later.

Structural and compositional characteristics of the metal organic framework may be usefully utilized in formation charging and discharging and thermal runaway situations of a rechargeable lithium battery. Specifically, when the sheet for a rechargeable lithium battery according to an embodiment is disposed inside the rechargeable lithium battery, an increase in battery volume and an increase in internal pressure may be prevented by trapping gas generated inside the rechargeable lithium battery during the first cycle charge and discharge (i.e., formation charge and discharge). Furthermore, even when the rechargeable lithium battery enters a thermal runaway situation where a short circuit occurs due to overcharge, heat exposure, and the like, the metal organic framework may effectively collect gas components (e.g., H₂, CO, CO₂, etc.) rapidly increasing inside the rechargeable lithium battery, so that the rechargeable lithium battery may be significantly less likely exploded.

In particular, in the separator for a rechargeable lithium battery of the embodiment, the metal organic framework may include ZIF-8, Fe-BTC, or a combination thereof, and each structure is as follows:

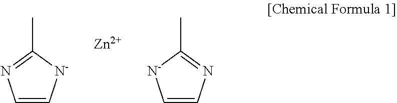

The ZIF-8 is represented by Chemical Formula 1, the coordination metal is Zn, and the linker is 2-methylimidazole. The ZIF-8 has a pore volume of 0.66 cm3/g and a BET specific surface area of 1300 to 1800 m²/g.

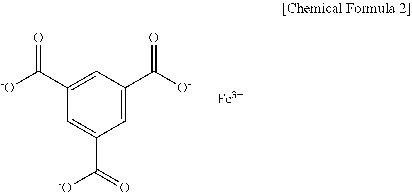

The Fe-BTC is represented by Chemical Formula 2, the coordination metal is Fe, and the linker is 1,3,5-benzenetricarboxylic acid. The Fe-BTC has a pore volume of 0.9 g/cm3 and a BET specific surface area of 1300 to 1600 m²/g.

According to the evaluation examples described below, the ZIF-8 and Fe-BTC have significantly superior gas capture effects not only compared to zeolites but also compared to other metal organic frameworks (e.g., ZIF-67, etc.).

Previous studies on metal organic frameworks known to date have shown that cations increase a polarity of metal organic frameworks, thereby enhancing physical adsorption of gas molecules, and anions increase chemical adsorption through coordination bonding of unshared electron pairs.

In this regard, it is presumed that the gas capture effects of the ZIF-8 and Fe-BTC are significantly superior to those of not only zeolites but also other metal organic frameworks because the synergistic effects of physical adsorption and chemical adsorption for gas components (e.g., H₂, CO, CO₂, etc.) generated from rechargeable lithium batteries are maximized due to the molecular structure.

### Additional Components of Coating Layer

The coating layer may further include a binder in addition to the metal organic framework structure, which is ZIF-8, Fe-BTC, or a combination thereof.

The binder may be a particle type binder and serves to bind the metal organic framework structures, which are ZIF-8, Fe-BTC, or a combination thereof, to each other or to bind them to the substrate.

The particle type binder may include polyvinylidene fluoride (PVdF), a styrene-butadiene rubber (SBR), carboxymethyl cellulose (CMC), a polyvinylidene fluoride-hexafluoropropylene (PVdF-HFP) copolymer, ethylene vinyl acetate (EVA), hydroxyethyl cellulose (HEC), polyvinyl alcohol (PVA), polyvinyl butyral (PVB), an ethylene-acrylic acid copolymer, acrylonitrile, a vinyl acetate derivative, polyethylene glycol, an acrylic rubber, or a combination thereof. The polyvinylidene fluoride may improve a bonding strength between the metal organic framework structure, which is the ZIF-8, Fe-BTC, or a combination thereof, and a bonding strength between it and the substrate. In an embodiment, the particle size of the particle type binder is not limited, and a particle type binder having a particle size generally used in the art may be used.

A weight ratio of the binder and the metal organic framework in the coating layer may be 0.3:9.7 to 5:5, specifically 0.4:9.6 to 5:5, and more specifically 0.4:9.6 to 4:6. Within this range, the dispersion of the binder and the metal organic framework within the coating solution, the bonding strength between the metal organic frameworks, and the bonding strength between the metal organic framework and the substrate may be excellently secured.

Meanwhile, in order to secure heat resistance or mechanical strength, inorganic filler particles and/or adhesive may be further included inside, on the upper and/or lower portions of the coating layer. For example, an additional coating layer including the inorganic filler particles and/or adhesive may be included in a single-layer or multilayer structure on top and/or bottom of the coating layer.

Specifically, the inorganic filler particles may be a metal oxide, a semi-metal oxide, or a combination thereof.

Specifically, the inorganic filler particles may be one or more selected from alumina (Al₂O₃), boehmite, BaSO₄, MgO, Mg(OH)₂, clay, silica (SiO₂), and (TiO₂). The alumina, silica, and the like have a small particle size, and thus it is easy to make a dispersion.

For example, the inorganic filler particles may be Al₂O₃, SiO₂, TiO₂, SnO₂, CeO₂, NiO, CaO, ZnO, MgO, ZrO₂, Y₂O₃, SrTiOs, BaTiO₃, MgF₂, Mg(OH)₂, or a combination thereof. The inorganic filler particles may have a sphere, plate shape, fiber shape, etc., but are not limited thereto, and any form usable in the art may be used.

The plate-shaped inorganic filler particles include, for example, alumina and boehmite. In this case, a reduction in the area of the separator at a high temperature may be further suppressed, a relatively large degree of porosity may be secured, and characteristics may be improved when evaluating the penetration of a lithium battery.

When the inorganic filler particles are sheet-shaped or fiber-shaped, the inorganic filler particles may have an aspect ratio of about 1:5 to 1:100. For example, the aspect ratio may be about 1:10 to 1:100. For example, the aspect ratio may be about 1:5 to 1:50. For example, the aspect ratio may be about 1:10 to 1:50.

The sheet-shaped inorganic filler particles may have a length ratio of a major axis to a minor axis of 1 to 3 on a planar surface. For example, the length ratio of a major axis to a minor axis on the planar surface may be 1 to 2. For example, the length ratio of a major axis to a minor axis on the planar surface may be about 1. The aspect ratio and the length ratio of a major axis to a minor axis may be measured through a scanning electron microscope (SEM). Within the aspect ratio range and the length ratio range of a major axis to a minor axis, a separator may be suppressed from contraction, securing relatively improved porosity may be secured and improving penetration characteristics of a lithium battery.

When the inorganic filler particles are plate-shaped, a planar surface of the inorganic filler particles with one surface of a porous substrate has an average angle of 0° to 30°. For example, the average angle of the planar surface of the inorganic filler particles with one surface of a porous substrate may be converged to 0°. In other words, the planar surface of the inorganic filler particles may be parallel with one surface of a porous substrate. For example, when the average angle of the planar surface of the inorganic filler particles with one surface of a porous substrate is within the ranges, the porous substrate may be effectively suppressed from thermal contraction, providing a separator with a reduced contraction rate.

Meanwhile, the adhesive may include a polymer adhesive in particle or solution type. Examples of the polymer adhesive may include polyvinylidene fluoride (PVdF), a polyvinylidene fluoride-hexafluoropropylene (PVdF-HFP) copolymer, or a combination thereof. When a separator with the polymer adhesive additionally coated thereon is used, a physical crosslinking phenomenon occurs between the polymer adhesive and the binder present in each of the positive and negative electrodes, so that the adhesive strength between the separator and the electrodes may be improved.

### Thickness and Area of Coating Layer

A thickness ratio of the coating layer to the substrate (coating layer thickness/substrate thickness) per one surface of the separator substrate may be 1/1000 to 5. For example, per one surface of the separator substrate, the thickness ratio of the coating layer to the substrate (coating layer thickness/substrate thickness) may be greater than or equal to 1/1000, greater than or equal to 1/100, or greater than or equal to 1/10, and less than or equal to 5, less than or equal to 4.2, less than or equal to 4, less than or equal to 3, less than or equal to 2, or less than or equal to 1.

Specifically, the thickness of the coating layer per one surface of the separator substrate may be greater than or equal to 50 nm. While the thickness ratio (coating layer thickness/substrate thickness) of the coating layer to the substrate per one surface of the separator substrate is less than 1/1000, when the coating layer has a thickness of less than 50 nm, there may be an insignificant gas capturing effect by the metal organic framework. In contrast, while the thickness ratio (coating layer thickness/substrate thickness) of the coating layer to the substrate per one surface of the separator substrate is greater than 5, when the coating layer has a thickness of greater than 30 μm, the gas capturing effect tends to be saturated.

Specifically, the thickness of the coating layer per one surface of the separator substrate may be greater than or equal to 50 nm, greater than or equal to 100 nm, greater than or equal to 500 nm, greater than or equal to 1 μm, greater than or equal to 5 μm, or greater than or equal to 10 μm. 50 nm [symbol] , 100 nm [symbol] , 500 mm [symbol] , 1μ [symbol] , 5μ [symbol] 10 μm [symbol] Herein, as the thickness of the coating layer per one surface of the separator substrate is closer to greater than or equal to 10 μm, the gas capturing effect may be increased by the metal organic framework.

In addition, the thickness of the coating layer per one surface of the separator substrate may be less than or equal to 30 μm or less than or equal to 20 μm. The gas capturing effect when the thickness of the coating layer per one surface of the separator substrate is within a range of greater than or equal to 10 μm to 20 μm may be equivalent with the gas capturing effect when the thickness of the coating layer per one surface of the separator substrate is within a range of greater than 20 μm to less than or equal to 30 μm. Accordingly, considering economic feasibility, the thickness of the coating layer may be less than or equal to 20 μm.

On the other hand, the larger the separator has a larger area per one surface of a substrate, the better the gas capturing effect. In this regard, the coating layer may be coated on the entire surface of the substrate, wherein the coating layer may be present on one surface or both surfaces of the substrate. In particular, when the coating layer exists both of entire surfaces of the substrate, the gas-capturing effect may be excellent, compared with when the coating layer exists on only one surface of the substrate.

For reference, if the binder is included in the coating layer, the thickness and the area of the coating layer include a thickness and an area due to the binder. Herein, the “thickness” may be measured through a photograph taken with a thickness meter or an optical microscope such as a scanning electron microscope. For example, the thickness of the coating layer in the separator may be measured by cutting the separator in a thickness direction and measuring a length between the lowest and the highest ends of the coating layer by using a commercially available thickness meter. Alternatively, the thickness of the coating layer may be obtained by taking an image of the cut surface of the separator with an optical microscope such as a scanning electron microscope and the like and calculating the length between the lowest and the highest ends of the coating layer shown on the image.

On the other hand, the “area” may be measured through photographs taken with an optical microscope, such as a scanning electron microscope. For example, the area of the coating layer in the separator may be obtained by taking an image of the separator from the top with an optical microscope such as a scanning electron microscope and the like and calculating the area of the coating layer shown in the image.

### Shape (Pattern) of Coating Layer

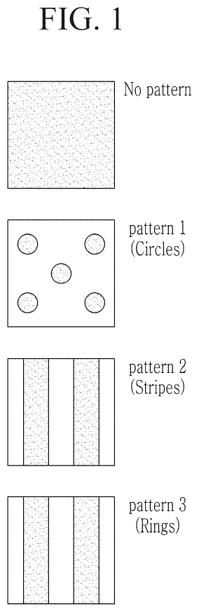

The coating layer may be patterned. In this way, the gas diffusion area is expanded in the patterned coating layer, and thus the gas capture effect can be further enhanced. Specifically, FIG. 1 illustrates various shapes (patterns) of the positive electrode active material layer. The coating layer may be patterned into a plurality of dots, lines, rings, or a combination thereof. However, the embodiment is not limited thereto and may include a non-patterned coating layer, in which case excellent gas capture effects may also be exhibited.

### Method for Forming Coating Layer

Any method that may be used in the relevant technical field may be used to form the coating layer.

Specifically, a slurry-phase coating solution may be prepared by dispersing the metal organic framework, which is ZIF-8, Fe-BTC, or a combination thereof, in a suitable dispersion solvent, to which the binder may be added. Thereafter, the separator of the embodiment may be completed by coating the coating solution on the substrate, and then going through processes such as drying and compressing.

The solvent is not particularly limited as long as it is a solvent capable of dispersing the metal organic framework structure, which is ZIF-8, Fe-BTC, or a combination thereof, and the binder, and may be, for example, methylpyrrolidone (NMP).

A total amount of solid content (i.e., the metal organic framework structure, which is ZIF-8, Fe-BTC, or a combination thereof, and the binder) in the coating solution may be 0.5 to 30 wt %. Within this range, the dispersibility of the coating solution is appropriately controlled so that it may be uniformly applied onto the substrate.

The method for applying the coating solution on the above-mentioned substrate is not particularly limited, and any method that can be used in the relevant technical field may be used. For example, methods such as printing, compression, indentation, roller application, blade application, brush application, dipping application, spray application or flow application may be used.

### Substrate

The substrate may be a porous substrate. The above porous substrate may be a porous film including polyolefin. Because polyolefin is a material that can implement a shutdown effect as well as an excellent short-circuit prevention effect, a porous substrate including the polyolefin may improve battery stability. In addition, the porous substrate including the polyolefin may improve the coating properties of a coating solution applied thereon, and may reduce the thickness of the resulting coating layer. Accordingly, when the porous substrate including the polyolefin is used, a total thickness of the separator including the porous substrate and the coating layer formed thereon becomes thinner, so that a ratio of electrode active material in the battery may be relatively increased, and the capacity per unit volume of the battery may be increased.

Meanwhile, the above-described film may be a single-layer film including a polyolefin such as polyethylene or polypropylene, or a multilayer film of two or more layers including the polyolefin in each layer.

Specifically, the above-described material may be a laminate (a three-layer film of PP/PE/PP) in which a first layer including polypropylene, a second layer including polyethylene, and a third layer including polypropylene are sequentially laminated. The three-layer film of PP/PE/PP has a high synergy effect with the metal organic framework structure, which is ZIF-8, Fe-BTC, or a combination thereof, compared to a single-layer film including a polyolefin such as polyethylene or polypropylene, or a two-layer film including the polyolefin in each layer. Furthermore, the three-layer film of PP/PE/PP has superior mechanical strength compared to a single-layer film including polyolefin such as polyethylene or polypropylene or a two-layer film including the polyolefin in each layer, and thus can have stronger resistance to shrinkage and deformation, and in particular, it is estimated to have relatively less interference with the diffusion of gas generated at high temperatures to the metal organic framework.

A thickness of the above-mentioned substrate may be 1 μm to 100 μm, 1 μm to 30 μm, 3 μm to 20 μm, 3 μm to 15 μm, or 3 μm to 12 μm. If the thickness of the above substrate is less than 1 μm, it may be difficult to maintain the mechanical properties of the separator, and if the thickness of the above substrate is more than 100 μm, the internal resistance of the lithium battery may increase.

A porosity of the above-described composition may be 5% to 95%. If the porosity is less than 5%, the internal resistance of the lithium battery may increase, and if the porosity is more than 95%, it may be difficult to maintain the mechanical properties of the porous substrate.

A pore size of the above-described material may be from 0.01 μm to 50 μm. For example, the pore size of the porous substrate in the membrane may be 0.01 μm to 20 μm. For example, the pore size of the porous substrate in the membrane may be 0.01 μm to 10 μm. If the pore size of the porous substrate is less than 0.01 μm, the internal resistance of the lithium battery may increase, and if the pore size of the porous substrate is more than 50 μm, it may be difficult to maintain the mechanical properties of the porous substrate.

### [Rechargeable Lithium Battery]

In another embodiment, a rechargeable lithium battery is provided including the sheet for a rechargeable lithium battery of the aforementioned embodiment.

A rechargeable lithium battery including an exterior material having an inner surface coated with a metal organic framework structure, which is ZIF-8, Fe-BTC or a combination thereof, has a significantly reduced risk of explosion even when a thermal runaway situation occurs and the amount of gas generated inside thereof rapidly increases, as the metal organic framework captures the rapidly increasing gas.

Hereinafter, the rechargeable lithium battery is described in detail, excluding any explanation that overlaps with the above-mentioned contents.

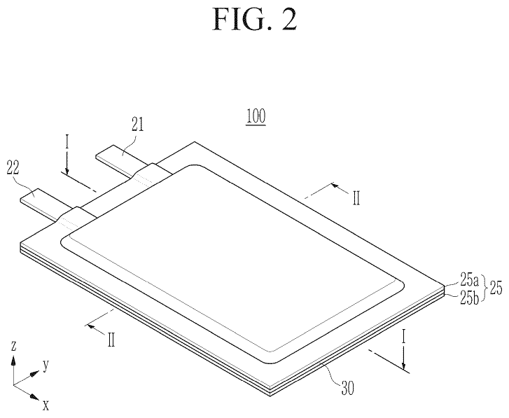

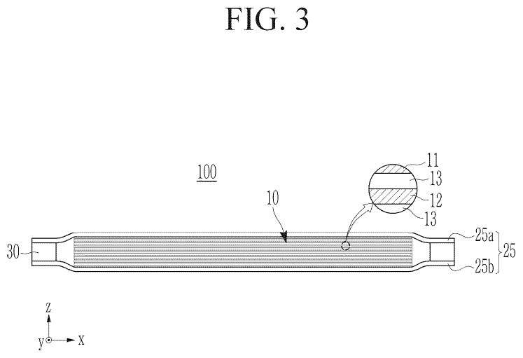

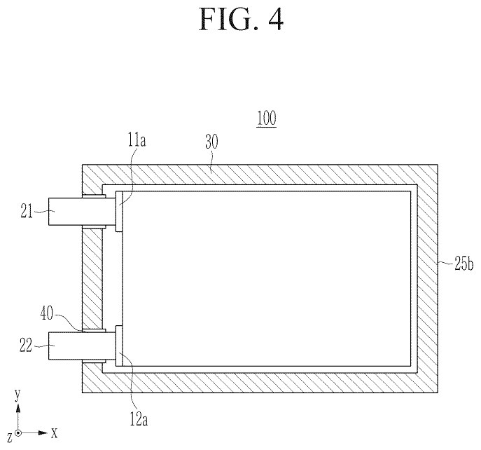

FIG. 2 is a perspective view of a pouch type rechargeable battery according to an embodiment, FIG. 3 is a vertical cross-sectional view taken along line I-I in FIG. 2 in the direction of the arrow, and FIG. 4 is a horizontal cross-sectional view taken along line II-II in FIG. 2 in the direction of the arrow. Herein, a rechargeable lithium battery according to an embodiment is described as an example in which a stack type electrode assembly is mounted in a pouch type case, but the present invention is not limited thereto, and may be applied to a battery in which an electrode assembly of a stack type, a winding type (jelly-roll type), a stack and folding type, a Z-folding type, etc. is mounted in a case of a cylindrical, prismatic, coin shape, etc.

Referring to FIGS. 2 to 4, a pouch type rechargeable battery 100 according to an embodiment includes an electrode assembly 10 having a separator 13 between a positive electrode 11 and a negative electrode 12, an exterior material 25 in which the electrode assembly 10 is housed, and a positive electrode terminal 21 electrically connected to the positive electrode 11, and a negative electrode terminal 22 electrically connected to the negative electrode 12.

Meanwhile, the electrode assembly 10 may have a structure in which a plurality of positive electrodes 11 and a plurality of negative electrodes 12 in the shape of square sheets are alternately stacked with a separator 13 interposed therebetween. An embodiment is not limited thereto, and may have a structure in which one positive electrode 11 and one negative electrode 12 are stacked with one separator 13 interposed therebetween. Additionally, the electrode assembly may be formed into a structure in which a separator is interposed between a band-shaped positive electrode and negative electrode and then wound.

In the electrode assembly 10, a positive electrode uncoated region 11a and a negative electrode uncoated region 12a are disposed at one end, and a positive electrode terminal 21 is attached by welding to the positive electrode uncoated region 11a, and a negative electrode terminal 22 is attached by welding to the negative electrode uncoated region 12a.

The positive electrode 11, negative electrode 12, and separator 13 may each be formed in a square sheet shape. The electrode assembly 10 may be housed inside the exterior material 25 and sealed by a sealing portion 30 along the edge of the exterior material 25, but is not limited thereto.

The exterior material 25 may include an upper exterior material 25a and a lower exterior material 25b. The upper exterior material 25a and the lower exterior material 25b may each have a multilayer structure. The structures of the upper exterior material 25a and the lower exterior material 25b are the same, and will be explained as an example based on the upper exterior material 25a. The upper exterior material 25a may have a configuration in which an outer resin layer, a metal layer, and an inner resin layer are sequentially stacked.

The sealing portion 30 may be located at the edge of the exterior material 25, as shown in FIG. 2, but is not limited thereto. An insulating member 40 may be attached to each of the positive electrode terminal 21 and the negative electrode terminal 22, but is not limited thereto.

### Positive Electrode

The positive electrode includes a current collector and a positive electrode active material layer on the current collector.

The positive electrode active material layer includes a positive electrode active material and may further include a positive electrode binder and/or a conductive material.

As the positive electrode active material, a compound capable of reversible intercalation and deintercalation of lithium (a lithiated intercalation compound) may be used. Examples of the positive electrode active material include a compound represented by any one of the following formulas:

LiₐA_{1-b}X_{b}D₂ (0.90≤a≤1.8,0≤b≤0.5);

LiₐA_{1-b}X_{b}O_{2-c}D_{c} (0.90≤a≤1.8,0≤b≤0.5,0≤c≤0.05);

LiₐE₁₋₆X_{b}O_{2-c}D_{c} (0.90≤a≤1.8,0≤b≤0.5,0≤c≤0.05);

LiₐE_{2-b}X_{b}O_{4-c}D_{c} (0.90≤a≤1.8,0≤b≤0.5,0≤c≤0.05);

LiₐNi_{1-b-c}Co_{b}X_{c}D_{α} (0.90≤a≤1.8,0≤b≤0.5,0≤c≤0.5,0<α≤2);

LiₐNi_{1-b-c}Co_{b}X_{c}O_{2-α}T_{α} (0.90≤a≤1.8,0≤b≤0.5,0≤c≤0.05,0<α<2);

LiₐNi_{1-b-c}Co_{b}X_{c}O_{2-α}T₂ (0.90≤a≤1.8,0≤b≤0.5,0≤c≤0.05,0<α<2):

LiₐNi_{1-b-c}Mn_{b}X_{c}D_{α} (0.90≤a≤1.8,0≤b≤0.5,0≤c≤0.05,0<α≤2);

LiₐNi_{1-b-c}Mn_{b}X_{c}O_{2-α}T_{α} (0.90≤a≤1.8,0≤b≤0.5,0≤c≤0.05,0<α≤2);

LiₐNi_{1-b-c}Mn_{b}X_{c}O_{2-α}T₂ (0.90≤a≤1.8,0≤b≤0.5,0≤c≤0.05,0<α<2);

LiₐNi_{b}E_{c}G_{d}O₂ (0.90≤a≤1.8,0≤b≤0.9, 0≤c≤0.5, 0.001≤d≤0.1);

LiₐNi_{b}Co_{c}Mn_{d}GₑO₂ (0.90≤a≤1.8,0≤b≤0.9, 0≤c≤0.5, 0≤d≤0.5,0.001≤e≤0.1);

LiₐNiG_{b}O₂ (0.90≤a≤1.8,0.001≤b≤0.1);

LiₐCoG_{b}O₂ (0.90≤a≤1.8,0.001≤b≤0.1);

LiₐMn_{1-b}G_{b}O₂ (0.90≤a≤1.8,0.001≤b≤0.1);

LiₐMn₂G_{b}O₄ (0.90≤a≤1.8,0.001≤b≤0.1);

LiₐMn_{1-g}G_{g}PO₄ (0.90≤a≤1.8,0≤g≤0.5);

QO₂;QS₂;LiQS₂;

V₂O₅;LiV₂O₅;

LiZO₂;

LiNiVO₄;

Li_{(3-f)}J₂(PO₄)₃ (0≤f≤2);

Li_{(3-f)}Fe₂(PO₄)₃ (0≤f≤2);

LiₐFePO₄ (0.90≤a≤1.8).

In the above chemical formulas, A is selected from Ni, Co, Mn, and a combination thereof; X is selected from Al, Ni, Co, Mn, Cr, Fe, Mg, Sr, V, a rare earth element, and a combination thereof; D is selected from O, F, S, P, and a combination thereof; E is selected from Co, Mn, and a combination thereof; T is selected from F, S, P, and a combination thereof; G is selected from Al, Cr, Mn, Fe, Mg, La, Ce, Sr, V, and a combination thereof; Q is selected from Ti, Mo, Mn, and a combination thereof; Z is selected from Cr, V, Fe, Sc, Y, and a combination thereof; and J is selected from V, Cr, Mn, Co, Ni, Cu, and a combination thereof.

The compounds may have a coating layer on the surface, or may be mixed with another compound having a coating layer. The coating layer may include at least one coating element compound selected from the group consisting of an oxide of a coating element, a hydroxide of a coating element, an oxyhydroxide of a coating element, an oxycarbonate of a coating element, and a hydroxyl carbonate of a coating element. The compound for the coating layer may be amorphous or crystalline. The coating element included in the coating layer may include Mg, Al, Co, K, Na, Ca, Si, Ti, V, Sn, Ge, Ga, B, As, Zr, or a combination thereof. The coating layer forming process may use a method that does not adversely affect the physical properties of the positive electrode active material, for example, spray coating, dipping, and the like.

For example, the positive electrode may include a composite oxide of lithium and at least one metal selected from nickel, cobalt, manganese, and aluminum as a positive electrode active material.

The positive electrode active material may include, for example, a lithium nickel composite oxide represented by Chemical Formula 11.

Liₐ₁₁Niₓ₁₁M¹¹_{y11}M¹²_{1-x11-y12}O₂ [Chemical Formula 11]

In Chemical Formula 11, 0.9≤a11≤1.8,0.3≤x11≤1, 0≤y11≤0.7, and M¹¹ and M¹² are independently are selected from Al, B, Ce, Co, Cr, F, Mg, Mn, Mo, Nb, P, S, Si, Sr, Ti, V, W, Zr, and a combination thereof.

In Chemical Formula 11, 0.4≤x11≤1 and 0≤y11≤0.6; 0.5≤x11≤1 and 0≤y11≤0.5; 0.6≤x11≤1 and 0≤y11≤0.4; 0.7≤x11≤1 and 0≤y11≤0.3; 0.8≤x11≤1 and 0≤y11≤0.2; or 0.9≤x11≤1 and 0≤y11≤0.1.

As a specific example, the second positive electrode active material may include a lithium nickel cobalt composite oxide represented by Chemical Formula 12.

Liₐ₁₂Niₓ₁₂Co_{y12}M¹³_{1-x12-y12}O₂ [Chemical Formula 12]

In Chemical Formula 12, 0.9≤a12≤1.8,0.3≤x12<1, 0<y12≤0.7, and M¹³ is selected from Al, B, Ce, Cr, F, Mg, Mn, Mo, Nb, P. S, Si, Sr, Ti, V, W, Zr, and a combination thereof.

In Chemical Formula 12, 0.3≤x12≤0.99 and 0.01≤y12≤0.7; 0.4≤x12≤0.99 and 0.01≤y12≤0.6; 0.5≤x12≤0.99 and 0.01≤y12≤0.5; 0.6≤x12≤0.99 and 0.01≤y12≤0.4; 0.7≤x12≤0.99 and 0.01≤y12≤0.3; 0.8≤x12≤0.99 and 0.01≤y12≤0.2; or 0.9≤x12≤0.99 and 0.01≤y12≤0.1.

As a specific example, the positive electrode active material may include a lithium nickel cobalt composite oxide represented by Chemical Formula 13.

Liₐ₁₃Niₓ₁₃Co_{y13}M¹⁴_{z13}M¹⁵_{1-x13-y13-z13}O₂ [Chemical Formula 13]

In Chemical Formula 13, 0.9≤a13≤1.8,0.3≤x13≤0.98,0.01≤y13≤0.69, 0.01≤z13≤0.69, M¹⁴ is selected from Al, Mn, and a combination thereof, and M¹⁵ is selected from B, Ce, Cr, F, Mg. Mo, Nb, P, S, Si, Sr, Ti. V, W, Zr, and a combination thereof.

In Chemical Formula 13, 0.4≤x13≤0.98,0.01≤y13≤0.59, and 0.01≤z13≤0.59; 0.5≤x13≤0.98,0.01≤y13≤0.49, and 0.01≤z13≤0.49; 0.6≤x13≤0.98,0.01≤y13≤0.39, and 0.01≤z13≤0.39; 0.7≤x13≤0.98, 0.01≤y13≤0.29, and 0.01≤z13≤0.29; 0.8≤x13≤0.98,0.01≤y13≤0.19, and 0.01≤z13≤0.19; or 0.9≤x13≤0.98,0.01≤y13≤0.09, and 0.01≤z13≤0.09.

For more specific examples, an LCO-based positive electrode active material, a high-Ni NCA-based positive electrode active material, high-Ni NCM-based positive electrode active material, or a combination thereof (representatively, LiCoO₂, LiNi_{0.91}Co_{0.07}Al_{0.02}O₂, LiNi_{0.82}Co_{0.11}Mn_{0.07}O₂, or a combination thereof) may be used as the positive electrode active material. These materials increase the amount of gas generated from the positive electrode during operation of a rechargeable lithium battery. Even in this case, the metal organic framework structure, such as ZIF-8, Fe-BTC or a combination thereof, can effectively capture gas.

A content of the positive electrode active material may be 85 wt % to 99 wt %, for example 90 wt % to 95 wt % based on a total weight of the positive electrode active material layer. Each content of the binder and the conductive material may be 1 wt % to 5 wt % based on a total weight of the positive electrode active material layer.

The positive electrode binder improves binding properties of positive electrode active material particles with one another and with a current collector. Examples thereof may be polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but are not limited thereto.

The conductive material is used to impart conductivity to the electrode, and any material may be used as long as it does not cause chemical change in the battery to be configured and is an electron conductive material. Examples of the conductive material may include a carbon-based material such as natural graphite, artificial graphite, carbon black, acetylene black, ketjen black, carbon fiber, carbon nanotube, and the like; a metal-based material of a metal powder or a metal fiber, and the like including copper, nickel, aluminum silver, and the like; a conductive polymer such as a polyphenylene derivative; or a mixture thereof.

An aluminum foil may be used as the positive electrode current collector, but is not limited thereto.

### Negative Electrode

The negative electrode for a rechargeable lithium battery includes a current collector and a negative electrode active material layer formed on the current collector and including a negative electrode active material.

The negative electrode active material may include a material that reversibly intercalates/deintercalates lithium ions, a lithium metal, a lithium metal alloy, a material capable of doping and dedoping lithium, or transition metal oxide.

The material that reversibly intercalates/deintercalates lithium ions may include, for example crystalline carbon, amorphous carbon, or a combination thereof as a carbon-based negative electrode active material. The crystalline carbon may be non-shaped, or sheet, flake, spherical, or fiber shaped natural graphite or artificial graphite. The amorphous carbon may be a soft carbon, a hard carbon, a mesophase pitch carbonization product, calcined coke, and the like.

The lithium metal alloy includes an alloy of lithium and a metal selected from Na, K, Rb, Cs, Fr, Be, Mg, Ca, Sr, Si, Sb, Pb, In, Zn, Ba, Ra, Ge, Al, and Sn.

Meanwhile, the negative electrode may include a carbon-based negative electrode active material, a silicon-based negative electrode active material, or a combination thereof as a negative electrode active material.

The material capable of doping/dedoping lithium may be a Si-based negative electrode active material or a Sn-based negative electrode active material. The Si-based negative electrode active material may include silicon, a silicon-carbon composite, SiOx (0<x<2), a Si-Q alloy (wherein Q is an alkali metal, an alkaline-earth metal, a Group 13 element, a Group 14 element, a Group 15 element, a Group 16 element, a transition metal, a rare earth element, and a combination thereof, but not Si) and the Sn-based negative electrode active material may include Sn, SnO₂, a Sn—R alloy (wherein R is an alkali metal, an alkaline-earth metal, a Group 13 element, a Group 14 element, a Group 15 element, a Group 16 element, a transition metal, a rare earth element, and a combination thereof, but not Sn). At least one of these materials may be mixed with SiO₂. The elements Q and R may be selected from Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Tl, Ge, P, As, Sb, Bi, S, Se, Te, Po, and a combination thereof.

The silicon-carbon composite may be, for example, a silicon-carbon composite including a core including crystalline carbon and silicon particles and an amorphous carbon coating layer disposed on the surface of the core. The crystalline carbon may be artificial graphite, natural graphite, or a combination thereof. The amorphous carbon precursor may be a coal-based pitch, mesophase pitch, petroleum-based pitch, coal-based oil, petroleum-based heavy oil, or a polymer resin such as a phenol resin, a furan resin, or a polyimide resin. In this case, the content of silicon may be 10 wt % to 50 wt % based on a total weight of the silicon-carbon composite. In addition, the content of the crystalline carbon may be 10 wt % to 70 wt % based on a total weight of the silicon-carbon composite, and the content of the amorphous carbon may be 20 wt % to 40 wt % based on a total weight of the silicon-carbon composite. In addition, a thickness of the amorphous carbon coating layer may be 5 nm to 100 nm. An average particle diameter (D50) of the silicon particles may be 10 nm to 20 μm. The average particle diameter (D50) of the silicon particles may be preferably 10 nm to 200 nm. The silicon particles may exist in an oxidized form, and in this case, an atomic content ratio of Si:O in the silicon particles indicating a degree of oxidation may be a weight ratio of 99:1 to 33:66. The silicon particles may be SiOx particles, and in this case, the range of x in SiOₓ may be greater than 0 and less than 2. In the present specification, unless otherwise defined, an average particle diameter (D50) indicates a diameter of particles having a cumulative volume of 50 volume % in the particle size distribution.

The Si-based negative electrode active material or Sn-based negative electrode active material may be mixed with the carbon-based negative electrode active material. When the Si-based negative electrode active material or Sn-based negative electrode active material and the carbon-based negative electrode active material are mixed and used, the mixing ratio may be a weight ratio of 1:99 to 90:10. For example, a negative electrode active material may be used in which silicon and artificial graphite are mixed in a ratio of 1:99 to 90:10 or 1:99 to 10:90.

In the negative electrode active material layer, the negative electrode active material may be included in an amount of 50 wt % to 99 wt % or 60 wt % to 95 wt % based on a total weight of the negative electrode active material layer.

In an embodiment, the negative electrode active material layer further includes a negative electrode binder, and may optionally further include a conductive material. Each content of the negative electrode binder and conductive material in the negative electrode active material layer may be 1 wt % to 5 wt % based on a total weight of the negative electrode active material layer.

The negative electrode binder serves to well adhere the negative electrode active material particles to each other and also to adhere the negative electrode active material to the current collector. The binder may be a water-insoluble binder, a water-soluble binder, or a combination thereof.

Examples of the water-insoluble binder include polyvinyl chloride, carboxylated polyvinyl chloride, polyvinyl fluoride, an ethylene oxide-containing polymer, an ethylene propylene copolymer, polystyrene, polyvinylpyrrolidone, polyurethane, polytetrafluoro ethylene, polyvinylidene fluoride, polyethylene, polypropylene, polyamideimide, polyimide, or a combination thereof. The water-soluble binder may include a rubber binder or a polymer resin binder. The rubber binder may be selected from a styrene-butadiene rubber, an acrylated styrene-butadiene rubber, an acrylonitrile-butadiene rubber, an acrylic rubber, a butyl rubber, a fluororubber, and a combination thereof. The polymer resin binder may be selected from polyethylene oxide, polyvinylpyrrolidone, polyepichlorohydrin, polyphosphazene, polyacrylonitrile, an ethylene propylene diene copolymer, polyvinylpyridine, chlorosulfonated polyethylene, latex, a polyester resin, an acrylic resin, a phenol resin, an epoxy resin, polyvinyl alcohol, and a combination thereof.

When a water-soluble binder is used as the negative electrode binder, a cellulose-based compound capable of imparting viscosity may be further included. As the cellulose-based compound, one or more of carboxymethyl cellulose, hydroxypropylmethyl cellulose, methyl cellulose, or alkali metal salts thereof may be mixed and used. As the alkali metal, Na, K or Li may be used. The amount of the thickener used may be 0.1 parts by weight to 3 parts by weight based on 100 parts by weight of the negative electrode active material.

The conductive material is included to provide electrode conductivity. Any electrically conductive material may be used as a conductive material unless it causes a chemical change in a battery. Examples of the conductive material include a carbon-based material such as natural graphite, artificial graphite, carbon black, acetylene black, ketjen black, a carbon fiber, carbon nanotube, and the like; a metal-based material of a metal powder or a metal fiber including copper, nickel, aluminum silver, and the like; a conductive polymer such as a polyphenylene derivative; or a mixture thereof.

The negative electrode current collector may include one selected from a copper foil, a nickel foil, a stainless steel foil, a titanium foil, a nickel foam, a copper foam, a polymer substrate coated with a conductive metal, and a combination thereof.

### Separator

The separator separates a positive electrode and a negative electrode and provides a transporting passage for lithium ions and may be any generally-used separator in a lithium ion battery. In other words, it may have low resistance to ion transport and excellent impregnation for an electrolyte solution. For example, separator may be selected from a glass fiber, polyester, TEFLON, polyethylene, polypropylene, polytetrafluoroethylene, or a combination thereof. It may have a form of a non-woven fabric or a woven fabric. For example, lithium ion batteries mainly use polyolefin polymer separators such as polyethylene and polypropylene, and coated separators including ceramic components or polymer materials may be used to secure heat resistance or mechanical strength, and may optionally be used in a single-layer or multi-layer structure.

### Electrolyte

The electrolyte may be a liquid electrolyte including a non-aqueous organic solvent and a lithium salt, which may be impregnated into the separator of the above embodiment (specifically, within the pores of the substrate).

The non-aqueous organic solvent serves as a medium for transmitting ions taking part in the electrochemical reaction of a battery. The non-aqueous organic solvent may be a carbonate-based, ester-based, ether-based, ketone-based, or alcohol-based solvent, or aprotic solvent. The carbonate-based solvent may be dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like. The ester-based solvent may be methyl acetate, ethyl acetate, n-propyl acetate, dimethyl acetate, methyl propionate, ethyl propionate, γ-butyrolactone, decanolide, valerolactone, mevalonolactone, caprolactone, and the like. The ether-based solvent may be dibutyl ether, tetraglyme, diglyme, dimethoxyethane, 2-methyltetrahydrofuran, tetrahydrofuran, and the like and the ketone-based solvent may be cyclohexanone, and the like. In addition, the alcohol-based solvent may be ethyl alcohol, isopropyl alcohol, etc. and the aprotic solvent may be nitriles such as R—CN (where R is a C2 to C20 linear, branched, or cyclic hydrocarbon group and may include a double bond, an aromatic ring, or an ether bond), amides such as dimethylformamide, dioxolanes such as 1,3-dioxolane, sulfolanes, and the like.

The non-aqueous organic solvent may be used alone or in a mixture. When the organic solvent is used in a mixture, the mixture ratio may be controlled in accordance with a desirable battery performance.

In addition, in the case of the carbonate-based solvent, a mixture of a cyclic carbonate and a chain carbonate may be used. In this case, when the cyclic carbonate and the chain carbonate are mixed in a volume ratio of about 1:1 to 1:9, the electrolyte solution may exhibit excellent performance.

The non-aqueous organic solvent may further include an aromatic hydrocarbon-based organic solvent in addition to the carbonate-based solvent. In this case, the carbonate-based solvent and the aromatic hydrocarbon-based organic solvent may be mixed in a volume ratio of about 1:1 to about 30:1.

As the aromatic hydrocarbon-based solvent, an aromatic hydrocarbon-based compound represented by Chemical Formula I may be used.

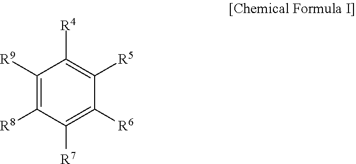

In Chemical Formula 1, R⁴ to R⁹ are the same or different and are selected from hydrogen, a halogen, a C1 to C10 alkyl group, a haloalkyl group, and a combination thereof.

Specific examples of the aromatic hydrocarbon-based solvent may be selected from benzene, fluorobenzene, 1,2-difluorobenzene, 1,3-difluorobenzene. 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 2,3-difluorotoluene, 2,4-difluorotoluene, 2,5-difluorotoluene, 2,3,4-trifluorotoluene, 2,3,5-trifluorotoluene, chlorotoluene, 2,3-dichlorotoluene, 2,4-dichlorotoluene, 2,5-dichlorotoluene, 2,3,4-trichlorotoluene, 2,3,5-trichlorotoluene, iodotoluene, 2,3-diiodotoluene, 2,4-diiodotoluene, 2,5-diiodotoluene, 2,3,4-triiodotoluene, 2,3,5-triiodotoluene, xylene, and a combination thereof.

The electrolyte solution may further include vinylene carbonate or an ethylene carbonate-based compound of Chemical Formula II in order to improve cycle-life of a battery.

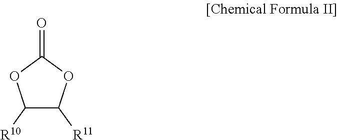

In Chemical Formula II, R¹⁰ and R¹¹ are the same or different, and are selected from hydrogen, a halogen, a cyano group, a nitro group, and fluorinated C1 to C5 alkyl group, provided that at least one of R¹⁰ and R¹¹ is selected from a halogen, a cyano group, a nitro group, and fluorinated C1 to C5 alkyl group, but both of R¹⁰ and R¹¹ are not hydrogen.

Examples of the ethylene-based carbonate-based compound may be difluoro ethylenecarbonate, chloroethylene carbonate, dichloroethylene carbonate, bromoethylene carbonate, dibromoethylene carbonate, nitroethylene carbonate, cyanoethylene carbonate, or fluoroethylene carbonate. The amount of the additive for improving cycle-life may be used within an appropriate range.

The lithium salt dissolved in the non-organic solvent supplies lithium ions in a battery, enables a basic operation of a rechargeable lithium battery, and improves transportation of the lithium ions between positive and negative electrodes.

Examples of the lithium salt may include at least one selected from LiPF₆, LiBF₄, LiSbF₆, LiAsF₆, LiN(SO₂C₂F₅)₂, Li(CF₃SO₂)₂N, LiN(SO₃C₂F₅)₂, Li(FSO₂)₂N (lithium bis(fluorosulfonyl)imide): LiFSI), LiCAF₉SO₃, LiClO₄, LiAlO₂, LiAlCl₄, LiPO₂F₂, LiN(CₓF₂ₓ₊₁SO₂)(C_{y}F_{2y+1}SO₂), wherein x and y are natural numbers, for example, an integer ranging from 1 to 20, lithium difluoro (bisoxolato) phosphate, LiCl, LiI, LiB(C₂O₄)₂ (lithium bis(oxalato) borate: LiBOB), and lithium difluoro (oxalato) borate (LiDFOB).

The lithium salt may be used in a concentration ranging from 0.1 M to 2.0 M. When the lithium salt is included at the above concentration range, an electrolyte may have excellent performance and lithium ion mobility due to optimal electrolyte conductivity and viscosity.

Meanwhile, as an additive of the electrolyte solution, other additives may be further included in addition to the aforementioned compound.

The other additives may include at least one of vinylene carbonate (VC), fluoroethylene carbonate (FEC), difluoroethylene carbonate, chloroethylene carbonate, dichloroethylene carbonate, bromoethylene carbonate, dibromoethylene carbonate, nitroethylene carbonate, cyanoethylene carbonate, vinylethylene carbonate (VEC), propensultone (PST), propanesultone (PS), lithium tetrafluoroborate (LiBFA), lithium difluorophosphate (LiPO₂F₂), and 2-fluorobiphenyl (2-FBP).

By further including the aforementioned other additives, cycle-life may be further improved, or gases generated from the positive electrode and the negative electrode may be effectively controlled when stored at a high temperature.

The other additives may be included in an amount of 0.2 to 20 parts by weight, specifically 0.2 to 15 parts by weight, for example, 0.2 to 10 parts by weight, based on 100 parts by weight of the electrolyte solution for a rechargeable lithium battery.

When the content of other additives is as described above, the increase in film resistance may be minimized, thereby contributing to the improvement of battery performance.

Rechargeable lithium batteries may be classified as lithium ion batteries, lithium ion polymer batteries, and lithium polymer batteries according to the presence of a separator and the type of electrolyte used therein. The rechargeable lithium batteries may have a variety of shapes and sizes, and include cylindrical, prismatic, coin, or pouch type batteries, and may be thin film batteries or may be rather bulky in size. Since the structure and manufacturing method of these batteries are well known in the art, a detailed description thereof will be omitted.

### MODE FOR INVENTION

Hereinafter, examples of the present invention and comparative examples are described. It is to be understood, however, that the examples are for the purpose of illustration and are not to be construed as limiting the present invention.

### PREPARATION EXAMPLES AND COMPARATIVE PREPARATION EXAMPLES

### Preparation Example 1

A coating solution (a solid content: 10 wt %) was prepared by mixing particle-type PVdF as a binder and ZIF-8 as a metal organic framework in a weight ratio of 1:9 and dispersing the mixture in NMP as a solvent.

A commercially available separator with a three layer structure of PP/PE/PP (a width: 30 mm, a length: 40 mm, air permeability: 121 sec./cc, each layer thickness: 4/6/4 μm, total thickness: 14 μm) was used as a substrate and then, dipped in the coating solution to form a coating layer on both surfaces thereof. Herein, the coating layer to the substrate was formed to have a thickness ratio (coating layer thickness/substrate thickness) of 1/10 and an area ratio (coating layer area/substrate area) of 1 (i.e., 100 sq %). Specifically, the coating layer had a thickness of 1.4 μm.

### Preparation Example 2

A separator for a rechargeable lithium battery of Preparation Example 2 was manufactured in the same manner as in Preparation Example 1 except that Fe-BTC was used instead of ZIF-8.

### Comparative Preparation Example 1

A separator for a rechargeable lithium battery of Preparation Comparative Preparation Example 1 was manufactured in the same manner as in Preparation Example 1 except that the separator with a three layer structure of PP/PE/PP itself without the coating layer was used.

### Comparative Preparation Example 2

A separator for a rechargeable lithium battery of Comparative Preparation Example 2 was manufactured in the same manner as in Preparation Example 1 except that zeolite (Product name: A-4 Zeolite, Manufacturer: Nakamura Choukou Co., Ltd.) was used instead of ZIF-8.

### Comparative Preparation Example 3

A separator for a rechargeable lithium battery of Comparative Preparation Example 3 was manufactured in the same manner as in Preparation Example 1 except that MOF-5 represented by the following chemical formula was used instead of ZIF-8.

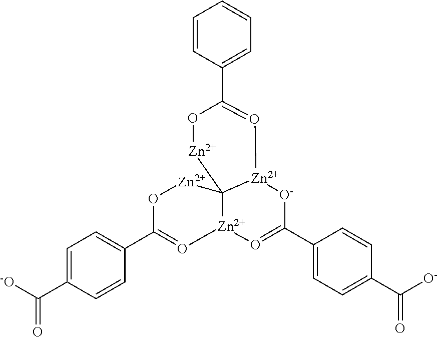

### Comparative Preparation Example 4

A separator for a rechargeable lithium battery of Comparative Preparation Example 4 was manufactured in the same manner as in Preparation Example 1 except that MOF-74 (Co) represented by the following chemical formula was used instead of ZIF-8.

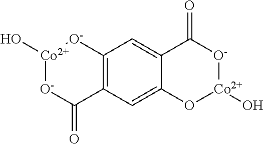

### Comparative Preparation Example 5

A separator for a rechargeable lithium battery of Comparative Preparation Example 5 was manufactured in the same manner as in Preparation Example 1 except that MOF-177 represented by the following chemical formula was used instead of ZIF-8.

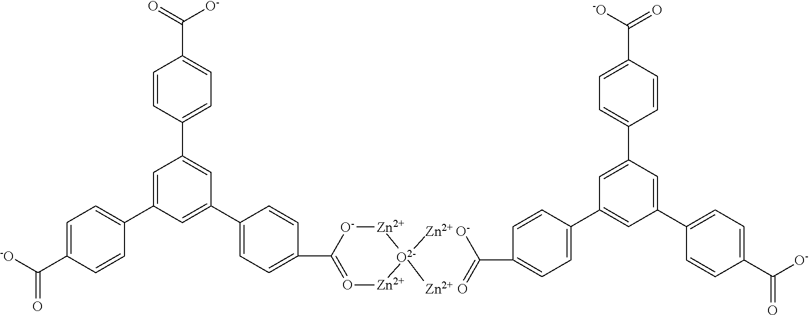

### Comparative Preparation Example 6

A separator for a rechargeable lithium battery of Comparative Preparation Example 6 was manufactured in the same manner as in Preparation Example 1 except that MOF-200 represented by the following chemical formula was used instead of ZIF-8.

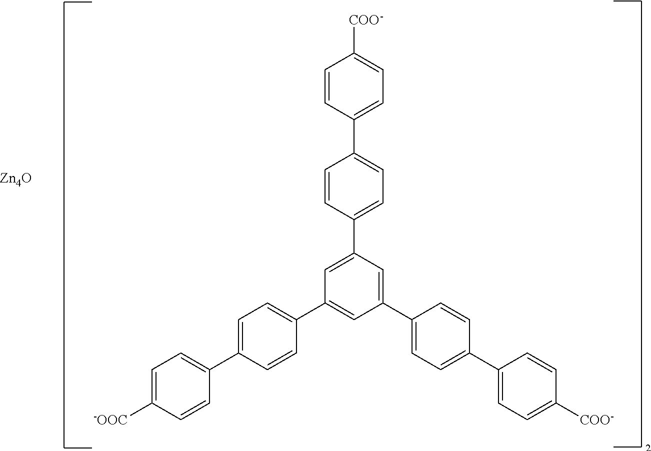

### Comparative Preparation Example 7

A separator for a rechargeable lithium battery of Comparative Preparation Example 7 was manufactured in the same manner as in Preparation Example 1 except that ZIF-67 represented by the following chemical formula was used instead of ZIF-8.

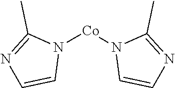

### Comparative Preparation Example 8

A separator for a rechargeable lithium battery of Comparative Preparation Example 8 was manufactured in the same manner as in Preparation Example 1 except that ZIF-68 represented by the following chemical formula was used instead of ZIF-8.

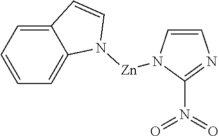

### Comparative Preparation Example 9

A separator for a rechargeable lithium battery of Comparative Preparation Example 9 was manufactured in the same manner as in Preparation Example 1 except that ZIF-69 represented by the following chemical formula was used instead of ZIF-8.

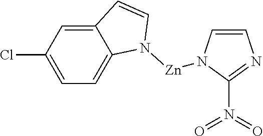

### Comparative Preparation Example 10

A separator for a rechargeable lithium battery of Comparative Preparation Example 10 was manufactured in the same manner as in Preparation Example 1 except that ZIF-78 represented by the following chemical formula was used instead of ZIF-8.

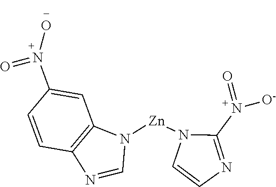

### Comparative Preparation Example 11

A separator for a rechargeable lithium battery of Comparative Preparation Example 11 was manufactured in the same manner as in Preparation Example 1 except that ZIF-81 represented by the following chemical formula was used instead of ZIF-8.

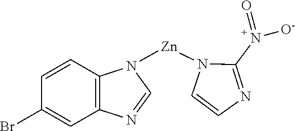

### Comparative Preparation Example 12

A separator for a rechargeable lithium battery of Comparative Preparation Example 12 was manufactured in the same manner as in Preparation Example 1 except that MIL-53(Al) represented by the following chemical formula was used instead of ZIF-8.

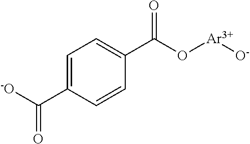

### Comparative Preparation Example 13

A separator for a rechargeable lithium battery of Comparative Preparation Example 13 was manufactured in the same manner as in Preparation Example 1 except that MIL-100(Fe) represented by the following chemical formula was used instead of ZIF-8.

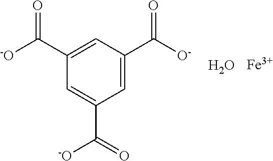

### Comparative Preparation Example 14

A separator for a rechargeable lithium battery of Comparative Preparation Example 14 was manufactured in the same manner as in Preparation Example 1 except that MIL-101(Fe) represented by the following chemical formula was used instead of ZIF-8.

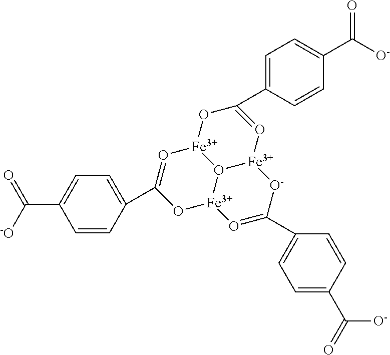

### Comparative Preparation Example 15

A separator for a rechargeable lithium battery of Comparative Preparation Example 15 was manufactured in the same manner as in Preparation Example 1 except that MIL-127(Fe) represented by the following chemical formula was used instead of ZIF-8.

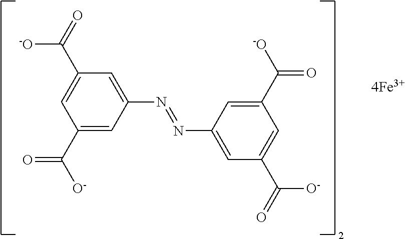

### Comparative Preparation Example 16

A separator for a rechargeable lithium battery of Comparative Preparation Example 16 was manufactured in the same manner as in Preparation Example 1 except that Cu-BTC represented by the following chemical formula was used instead of ZIF-8.

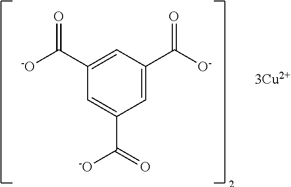

### Comparative Preparation Example 17

A separator for a rechargeable lithium battery of Comparative Preparation Example 17 was manufactured in the same manner as in Preparation Example 1 except that UiO-66 represented by the following chemical formula was used instead of ZIF-8.

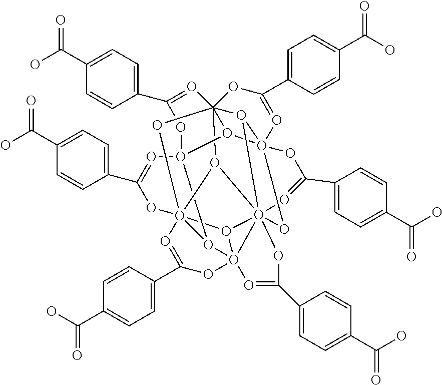

### Comparative Preparation Example 18

A separator for a rechargeable lithium battery of Comparative Preparation Example 18 was manufactured in the same manner as in Preparation Example 1 except that CPO-27 represented by the following chemical formula was used instead of ZIF-8.

[Rechargeable Lithium Battery Including LiNi_{0.91}Co_{0.07}Al_{0.02}O₂Positive Electrode Active Material and PP/PE/PP Separator]

### Example 1-1

### (1) Manufacturing of Negative Electrode

A negative electrode active material slurry was prepared by mixing 70 wt % of a negative electrode active material of artificial graphite (D50: 16.6 μm) and silicon (D50: 18.0 μm) in a weight ratio of 9:1, 15 wt % of a conductive material (Super-P), and 15 wt % of a binder (PAA (Poly Acrylic acid)) in water as a solvent. The negative electrode active material slurry was coated to a thickness of 140 μm on one surface of a copper foil having a thickness of 10 μm, dried, and compressed to manufacture a negative electrode having a total thickness of 120 μm. Herein, die coating was used as the method for coating the negative electrode active material slurry. After coating, it was first dried for 1 hour in an air atmosphere at 60° C., and then dried for 12 hours under vacuum conditions at 110° C. The dried negative electrode plate was cut into a size of 2.2×3.2 cm2.

### (2) Manufacturing of Positive Electrode

A positive electrode active material was prepared by mixing 95 wt % of LiNi_{0.91}Co_{0.07}Al_{0.02}O₂ as a positive electrode active material, 3 wt % of polyvinylidene fluoride as a binder, and 2 wt % of ketjen black as a conductive material in an N-methylpyrrolidone solvent. This was coated on one surface of an aluminum current collector having a thickness of 12 μm to a thickness of 164 μm, dried, and compressed to manufacture a positive electrode active material layer having a total thickness of 138 μm. Herein, die coating was used as the method for coating the positive electrode active material slurry. After coating, it was first dried for 1 hour in an air atmosphere at 80° C., and vacuum-dried for 12 hours in a vacuum condition at 120° C. The dried positive electrode plate was cut into cut into a size of 2×3 cm2.

### (3) Manufacturing of Battery Cell

The separator of Preparation Example 1 was inserted between the negative electrode and the positive electrode to manufacture an electrode assembly. After inserting the electrode assembly into a pouch, an electrolyte solution prepared by mixing ethylene carbonate and diethyl carbonate in a volume ratio of 30:70 and adding 1.5 M of LiPF₆ lithium salt and 12.5 wt % of FEC in the mixed solvent to manufacture a rechargeable lithium battery cell.

### Example 1-2

A separator for a rechargeable lithium battery of Example 1-2 was manufactured in the same manner as in Example 1-1 except that the separator for a rechargeable lithium battery of Preparation Example 2 was used.

### Comparative Examples 1-1 to 1-18

Each separator for a rechargeable lithium battery of Comparative Examples 1-1 to 1-18 was manufactured in the same manner as in Example 1-1 except that the separators for a rechargeable lithium battery of Preparation Examples 1 to 18 were respectively used.

### Evaluation Example 1: Evaluation of Rechargeable Lithium Battery Cell Including LiNi_{0.91}Co_{0.07}Al_{0.02}O₂Positive Electrode Active Material and PP/PE/PP Separator

### (1) Amount of Gas Generated During Formation Charging and Discharging

Each of the rechargeable lithium battery cells of Examples 1-1 to 1-2 and Comparative Examples 1-1 to 1-18 was evaluated with respect to an amount of gas generated during the formation charge and discharge, and the results are shown in Table 1.

Specifically, the formation charge and discharge of the rechargeable lithium battery cells was performed as 1 cycle of charge and discharge under the following condition at 25° C. (room temperature).
Charge condition: CC (constant current)/CV (constant voltage), 4.2 V, 0.02 C current cut-off
Discharge condition: CC (constant current), 2.5 V

After completing the formation charge and discharge under the condition, each of the rechargeable lithium battery cells was extracted with a syringe and then, injected into GC-MS to evaluate the amount of gas generated.

### (2) Amount of Gas Generated During Overcharging

The rechargeable lithium battery cells of Examples 1-1 to 1-2 and Comparative Examples 1-1 to 1-18 were evaluated with respect to an amount of gas generated during the overcharge, and the results are shown in Table 1.

Specifically, the amounts of gas generated of the rechargeable lithium battery cells during the overcharge were evaluated under the following conditions at an ambient temperature in an explosion-proof chamber.

Overcharge condition: 0.2 C CC (constant current) charge, 10 V. 7.5 Hr.

After completing the overcharge under the condition, an amount of gas generated was evaluated in the same manner as the method of evaluating the amount of gas generated during the formation charge and discharge.

(3) Amount of Gas Generated when Exposed to Heat

The rechargeable lithium battery cells of Examples 1-1 to 1-2 and Comparative Examples 1-1 to 1-18 were evaluated with respect to an amount of gas generated when exposed to heat, and the results are shown in Table 1. Specifically, the rechargeable lithium battery cells were charged to 4.2 V at a cut-off current of 0.02 C and then, heated to 140° C. at 5° C./min and allowed to stand at 140° C. for 1 hour.

After completing the overcharge under the condition, the amount of gas generated was evaluated in the same manner as the method of evaluating the amount of gas generated during the formation charge and discharge.

TABLE 1

| | Rechargeable lithium battery including | | |
|---|---|---|---|
| | LiNi_{0.91}Co_{0.05}Al_{0.04}O₂ positive electrode active | | |
| | material and PP/PE/PP separator - evaluation of | | |
| | amount of gas generated by condition | | |
| | Formation charge | Overcharge | Exposed to |
| | and discharge (μl) | (ml) | heat (ml) |
| Comparative Example 1-1 | 27.5 | 10.5 | 5.9 |
| Comparative Example 1-2 | 35.8 | 18.8 | 8.8 |
| Comparative Example 1-3 | 25.5 | 10.3 | 5.8 |
| Comparative Example 1-4 | 24.8 | 10.4 | 5.7 |
| Comparative Example 1-5 | 15.6 | 8.2 | 4.8 |
| Comparative Example 1-6 | 24.4 | 10.3 | 5.6 |
| Comparative Example 1-7 | 25.5 | 10.2 | 5.9 |
| Comparative Example 1-8 | 25.7 | 10.1 | 6.1 |
| Comparative Example 1-9 | 24.8 | 9.9 | 5.7 |
| Comparative Example 1-10 | 26.6 | 9.8 | 5.5 |
| Comparative Example 1-11 | 25.8 | 9.9 | 5.9 |
| Comparative Example 1-12 | 16.6 | 8.8 | 4.2 |
| Comparative Example 1-13 | 25.5 | 10.1 | 5.7 |
| Comparative Example 1-14 | 24.9 | 10.2 | 5.8 |
| Comparative Example 1-15 | 24.7 | 10.3 | 5.8 |
| Comparative Example 1-16 | 16.2 | 8.5 | 4.6 |
| Comparative Example 1-17 | 23.3 | 10.3 | 5.4 |
| Comparative Example 1-18 | 22.1 | 10.4 | 5.8 |
| Example 1-1 | 0 | 5.4 | 2.7 |
| Example 1-2 | 0 | 6.5 | 3.2 |

Referring to Table 1, compared with the rechargeable lithium battery cells of Comparative Examples 1-1 to 1-18, the rechargeable lithium battery cells of Examples 1-1 and 1-2 exhibited a very small amount of gas generated under the conditions of the formation charge and discharge, the overcharge, the heat exposure, and the like. Accordingly, if a separator for a rechargeable lithium battery including a metal organic framework such as ZIF-8, Fe-BTC, or a combination thereof in a coating layer is disposed inside a rechargeable lithium battery, gas generated inside the rechargeable lithium battery under the conditions such as formation charge and discharge, overcharge, heat exposure, and the like may be more effectively captured than any metal organic framework as well as zeolite to prevent an increase in a volume and an internal pressure of the battery.

On the other hand, among the rechargeable lithium battery cells of Examples 1-1 and 1-2, the cell of Example 1-1 using a sheet for a rechargeable lithium battery, which was coated with ZIF-8, exhibited a significantly small amount of gas generated. According to MOF-related literature (Hasmukh A. Patel et. al., ChemSusChem 2017, 10, 1303 to 1317), cations such as zinc ions and the like are known to increase polarity and thus a reaction area for gas adsorption reaction, and anions such as imidazole skeletons and the like are known to provide unshared electron pairs and thus increase chemical adsorption of gas molecules. The gas molecules may be chemically absorbed by the cations/anions on the MOF pore surface and physically adsorbed in nonpolar regions such as carbon and the like, but as farther from the pore surface, the physical adsorption mainly occurs due to Van der Waals forces rather the chemical adsorption. Accordingly, three factors such as a binding force for gas molecules by cations/anions, a surface area of materials, and a size of pores should be maximized to maximize gas adsorption capacity. ZIF-8 has the greatest gas reduction effect, which was estimated to have a structure of maximizing the effect for gas components generated from a rechargeable lithium battery.

### [Rechargeable Lithium Battery Including LiCoO₂ Positive Electrode Active Material and PP/PE/PP Separator]

### Examples 2-1 and 2-2

Each rechargeable lithium battery cell of Examples 2-1 and 2-2 was manufactured in the same manner as in Examples 1-1 and 1-2 except that LiCoO₂ was used instead of LiNi_{0.91}Co_{0.07}Al_{0.02}O₂ as the positive electrode active material.

### Comparative Examples 2-1 to 2-18

Each rechargeable lithium battery cell of Comparative Examples 2-1 to 2-18 was manufactured in the same manner as in Comparative Examples 1-1 to 1-18 except that LiCoO₂ was used instead of LiNi_{0.91}Co_{0.07}Al_{0.02}O₂ as the positive electrode active material.

### Evaluation Example 2: Evaluation of Rechargeable Lithium Battery Including LiCoO₂ Positive Electrode Active Material and PP/PE/PP Separator

The rechargeable lithium battery cells of Examples 2-1 to 2-2 and Comparative Examples 2-1 to 2-18 were evaluated with respect to an amount of gas generated under each condition of formation charge and discharge, overcharge, and heat exposure in the same manner as in Evaluation Example 1, and the results are shown in Table 2.

TABLE 2

| | Rechargeable lithium battery with LiCoO₂ | | |
|---|---|---|---|
| | positive electrode active material and PP/PE/PP | | |
| | separator - Evaluation of amount of gas | | |
| | generated by condition | | |
| | Formation charge | Overcharge | Exposed to |
| | and discharge (μl) | (ml) | heat (ml) |
| Comparative Example 2-1 | 23.2 | 10.9 | 4.2 |
| Comparative Example 2-2 | 30.2 | 14.4 | 5.8 |
| Comparative Example 2-3 | 23.1 | 10.8 | 4.1 |
| Comparative Example 2-4 | 22.8 | 10.2 | 4.2 |
| Comparative Example 2-5 | 14.2 | 9.1 | 3.7 |
| Comparative Example 2-6 | 22.1 | 10.4 | 4.1 |
| Comparative Example 2-7 | 22.5 | 10.3 | 4.3 |
| Comparative Example 2-8 | 23.1 | 10.5 | 4.1 |
| Comparative Example 2-9 | 22.5 | 10.5 | 4.1 |
| Comparative Example 2-10 | 22.4 | 10.8 | 4.2 |
| Comparative Example 2-11 | 21.1 | 10.7 | 4.2 |
| Comparative Example 2-12 | 15.5 | 9.1 | 3.6 |
| Comparative Example 2-13 | 20.8 | 10.4 | 4.1 |
| Comparative Example 2-14 | 21.9 | 10.5 | 4.1 |
| Comparative Example 2-15 | 23.4 | 10.4 | 4.4 |
| Comparative Example 2-16 | 16.3 | 9.2 | 3.7 |
| Comparative Example 2-17 | 20.5 | 10.4 | 4.4 |
| Comparative Example 2-18 | 20.5 | 10.3 | 4.2 |
| Example 2-1 | 0 | 5.8 | 1.8 |
| Example 2-2 | 0 | 6.6 | 2.2 |

Referring to Table 2, compared with the rechargeable lithium battery cells of Comparative Examples 2-1 to 2-18, the rechargeable lithium battery cells of Examples 2-1 and 2-2 exhibited a very small amount of gas generated under the conditions such as formation charge and discharge, overcharge, heat exposure, and the like. In addition, among the rechargeable lithium battery cells of Example 2-1 and 2-2, the cell of Example 2-1 using a sheet for a rechargeable lithium battery in which ZIF-8 was coated exhibited a significantly small amount of gas generated. Accordingly, the same result as in Evaluation Example 1 was obtained.

### Evaluation Example 3: Evaluation of Changes in Separator Substrate and/or Positive Electrode Active Material

Each separator of Evaluation Example 3 was manufactured by changing the separator substrate and/or the metal organic framework from Preparation Example 1. Specifically, a separator with one layer structure of PP (width: 30 mm, length: 40 mm, thickness: 14 μm, air permeability: 145 sec./cc, total thickness: 14 μm) or a separator with a three layer structure of PP/PE/PP (width: 30 mm, length: 40 mm, porosity: 121 sec./cc, each layer thickness: 4/6/4 μm, total thickness: 14 μm) was used. In addition, on both entire surfaces of the separator substrate, no coating layer including a metal organic framework or a coating layer including ZIF-67, ZIF-8, or Fe-BTC was formed. The other matters except for this were the same as in Preparation Example 1 to manufacture the separator.

Subsequently, while using the separator manufactured in the above method, LiNi_{0.91}Co_{0.07}Al_{0.02}O₂ LiCoO₂, LiNi_{0.82}Co_{0.11}Mn_{0.07}O₂, or LiMn₂O₄ was used as the positive electrode active material. The other matters except for this were the same as in Example 1-1 to manufacture each rechargeable lithium battery cell of Evaluation Example 3.

Each rechargeable lithium battery cell of Evaluation Example 3 was evaluated with respect to heat exposure under the same condition as in Evaluation Example 1, and the amount of gas generated results are shown in Table 3.

TABLE 3
(unit: mL)

| Coating | LiNi_{0.91}Co_{0.07}Al_{0.02}O₂ | | LiCoO₂ | | LiNi_{0.82}Co_{0.11}Mn_{0.07}O₂ | | LiMn₂O₄ | |
|---|---|---|---|---|---|---|---|---|
| material | PP | PP/PE/PP | PP | PP/PE/PP | PP | PP/PE/PP | PP | PP/PE/PP |
| None coating | 7.1 | 5.9 | 5.3 | 4.2 | 6.1 | 5.2 | 4.6 | 3.8 |
| ZIF-67 | 7.3 | 5.9 | 5.5 | 4.3 | 5.9 | 5.1 | 2.3 | 3.7 |
| ZIF-8 | 6.6 | 2.7 | 4.7 | 1.8 | 5.7 | 2.3 | 4.2 | 1.9 |
| Fe-BTC | 6.9 | 3.2 | 4.9 | 2.2 | 5.9 | 2.8 | 4.4 | 2.1 |

Referring to Table 3, when the same separator substrate was used, compared with the separator with no coating or with ZIF-67 coating, the separator with ZIF-8 coating or Fe-BTC coating exhibited a very small amount of gas generated. On the other hand, when ZIF-8 or Fe-BTC was used as a separator coating material, compared with a PP monolayer separator, while using LiNi_{0.91}Co_{0.07}Al_{0.02}O₂, LiCoO₂, LiNi_{0.82}Co_{0.11}Mn_{0.07}O₂, or a combination thereof as a positive electrode active material, a PP/PE/PP separator exhibited a significantly high gas reduction effect. It is estimated that a stack-type separator has more excellent mechanical strength and thus much stronger resistance to shrinkage and deformation and thereby, relatively less interferes diffusion of gas generated particularly at a high temperature to MOF than a monolayer separator. However, when the PP separator is combined with a LiMn₂O₄positive electrode, ZIF-67 exhibits better gas capturing effect than ZIF-8 and Fe-BTC. Accordingly, the gas capturing effect may vary depending on a positive electrode and a separator combined therewith.

### Evaluation Example 4: Evaluation of Changes in Weight Ratio of Binder: Metal Organic Framework and/or Solid Content in Coating Solution

Each coating solution and separator of Evaluation Example 4 was manufactured by changing a weight ratio of binder: metal organic framework and/or a solid content in a coating solution from Preparation Example 1.

Specifically, while the weight ratio of binder: metal organic framework was changed within a range of 0.3:9.7 to 5:5, a coating layer was formed on both surfaces of a separator substrate by using ZIF-8 or Fe-BTC. The other matters except for this were the same as in Preparation Example 1 to manufacture the separators.

Each coating solution and separator of Evaluation Example 4 were evaluated under the following condition, and the results are shown in Table 3.

Coating solution dispersion evaluation condition: a solid content (binder+MOF) in a total weight of a coating solution (solvent+binder+MOF) was measured by using a moisture meter (Infrared Moisture Analyzer, Product mane: MA35M-230N, Manufacturer: Sartorius mechatronics). The closer a measurement value to an input reference value (10 wt %), the higher the dispersibility.

Coating layer uniformity evaluation condition: A thickness of the coating layer was measured at any 8 point in a separator, and its deviation was calculated.

TABLE 4

| | Based on 10 wt % solid content, Actual solid content of coating | | | | | | | |
|---|---|---|---|---|---|---|---|---|
| | solution according to change in binder:MOF weight ratio | | | | | | | |
| Coating | (unit: weight %) | | | | | | | |
| material | 0.3:9.7 | 0.4:9.6 | 0.5:9.5 | 1:9 | 2:8 | 3:7 | 4:6 | 5:5 |
| ZIF-8 | 8.8 | 10.6 | 10.2 | 10.1 | 9.9 | 9.9 | 9.9 | 10.1 |
| Fe-BTC | 7.8 | 10.1 | 9.9 | 9.8 | 10.2 | 9.9 | 10.1 | 10.1 |
| | Based on 10 wt % solid content, 5 μm coating on both sides, | | | | | | | |
| | Binder:Coating layer thickness deviation according to change in | | | | | | | |
| Coating | MOF weight ratio (unit: μm) | | | | | | | |
| material | 0.3:9.7 | 0.4:9.6 | 0.5:9.5 | 1:9 | 2:8 | 3:7 | 4:6 | 5:5 |
| ZIF-8 | ±1.4 | ±0.1 | ±0.1 | ±0.1 | ±0.2 | ±0.1 | ±0.0 | ±0.0 |
| Fe-BTC | ±1.2 | ±0.2 | ±0.1 | ±0.1 | ±0.1 | ±0.1 | ±0.0 | ±0.1 |

Referring to Table 4, if a solid content was the same in a coating solution, when a weight ratio of binder: MOF was within a range of 0.3:9.7 to 5:5, specifically, 0.4:9.6 to 5:5, and more specifically, 0.4:9.6 to 4:6, dispersibility of the coating solution and uniformity of the coating layer were improved.

### Evaluation Example 5: Evaluation of an Example of Changing the Thickness of the Coating Layer

Each separator of Evaluation Example 5 was manufactured by changing the coating layer thickness from Preparation Example 1. Specifically, while changing the coating layer thickness per one surface of a separator within a range of 0.05 to 30 μm, the coating layer was not formed, or the coating layer was formed on both of the surfaces of the separator by using ZIF-8 or Fe-BTC. The other matters except for this were the same as in Preparation Example 1 to manufacture the separators.

Subsequently, each rechargeable lithium battery cell of Evaluation Example 5 was manufactured in the same manner as in Example 1-1 except that the separators manufactured in the above method were respectively used.

Each rechargeable lithium battery cell of Evaluation Example 5 was evaluated with respect to an amount of gas generated during the heat exposure under the same condition as in Evaluation Example 1, and the results are shown in Table 5.

TABLE 5
(unit: mL)

| | Amount of gas generated according to change in coating | | | | | | | |
|---|---|---|---|---|---|---|---|---|
| Coating | layer thickness | | | | | | | |
| material | 0.05 μm | 0.1 μm | 0.5 μm | 1 μm | 5 pm | 10 μm | 20 μm | 30 μm |
| None | | | | 5.9 | | | | |
| coating | | | | | | | | |
| ZIF-8 | 5.6 | 4.4 | 3.9 | 3.4 | 2.7 | 1.9 | 1.1 | 1.2 |
| Fe-BTC | 5.8 | 4.8 | 4.2 | 3.7 | 3.2 | 2.3 | 1.8 | 1.8 |

Referring to Table 5, as far as the separators had a coating layer formed by using ZIF-8 or Fe-BTC, an amount of gas generated in the rechargeable lithium battery cells was reduced regardless of a thickness of the coating layer. In particular, when the separators had a coating layer formed by using ZIF-8 or Fe-BTC, a coating layer with a thickness of 100 to 20 μm per one surface of the separator, compared with a coating layer with a thickness of less than 100 μm, exhibited the most excellent effect but an equivalent effect with a coating layer with a thickness of 20 μm or more.

While this disclosure has been described in connection with what is presently considered to be practical example embodiments, it is to be understood that the invention is not limited to the disclosed embodiments. On the contrary, it is intended to cover various modifications and equivalent arrangements included within the spirit and scope of the appended claims.

### DESCRIPTION OF SYMBOLS

| | |
|---|---|
| 100: pouch type rechargeable battery | 10: electrode assembly |
| 11: positive electrode | |
| 11a: positive electrode uncoated region | |
| 12: negative electrode | 12a: negative uncoated region |
| 13: separator | |
| 21: positive electrode terminal | 22: negative electrode terminal |
| 25: exterior material | |
| 25a: upper exterior material | 25b: lower exterior material |
| 30: sealing portion | |
| 40: insulation member | |

1. A separator for a rechargeable lithium battery, the separator comprising
a substrate; and
a coating layer located on one or both surfaces of the substrate and including a metal organic framework of comprising at least one of ZIF-8, and Fe-BTC.

2. The separator for a rechargeable lithium battery as claimed in claim 1, wherein the substrate includes polyolefin.

3. The separator for a rechargeable lithium battery as claimed in claim 2, wherein
the substrate is a laminate in which a first layer including polypropylene, a second layer including polyethylene, and a third layer including polypropylene are sequentially laminated.

4. The separator for a rechargeable lithium battery as claimed in claim 1, wherein the coating layer further includes a binder.

5. The separator for a rechargeable lithium battery as claimed in claim 4, wherein the binder comprises at least one of polyvinylidene fluoride (PVdF), a styrene-butadiene rubber (SBR), carboxymethyl cellulose (CMC), a polyvinylidene fluoride-hexafluoropropylene (PVdF-HFP) copolymer, ethylene vinyl acetate (EVA), hydroxyethyl cellulose (HEC), polyvinyl alcohol (PVA), polyvinyl butyral (PVB), an ethylene-acrylic acid copolymer, acrylonitrile, a vinyl acetate derivative, polyethylene glycol, and an acrylic rubber.

6. The separator for a rechargeable lithium battery as claimed in claim 4, wherein a weight ratio of the binder and the metal organic framework in the coating layer is 0.3:9.7 to 5:5.

7. The separator for a rechargeable lithium battery as claimed in claim 1, wherein a thickness ratio of the coating layer to the substrate per one surface of the separator substrate is 1/1000 to 5.

8. The separator for a rechargeable lithium battery as claimed in claim 1, wherein a thickness of the coating layer per one surface of the separator substrate is 50 nm to 30 μm.

9. The separator for a rechargeable lithium battery as claimed in claim 1, wherein the coating layer is entirely coated on one surface of the substrate.

10. The separator for a rechargeable lithium battery as claimed in claim 1, wherein the coating layer is patterned in a form of a plurality of dots, lines, rings, or a combination thereof.

11. A rechargeable lithium battery comprising the separator for a rechargeable lithium battery as claimed in claim 1.

12. The rechargeable lithium battery as claimed in claim 11, wherein the rechargeable lithium battery includes an assembly in which a positive electrode and a negative electrode are located with the separator interposed therebetween.

13. The rechargeable lithium battery as claimed in claim 11, wherein the positive electrode includes a composite oxide of lithium and at least one metal selected from nickel, cobalt, manganese, and aluminum as a positive electrode active material.
